(19) United States
(12) Patent Application Publication
(10) Pub. No.: US 2024/0355516 A1
(43) Pub. Date: Oct. 24, 2024

(54) SM-FE-N-BASED MAGNETIC MATERIAL AND PRODUCTION METHOD THEREOF

(71) Applicant: TOYOTA JIDOSHA KABUSHIKI KAISHA, Toyota-shi (JP)

(72) Inventors: Tetsuya SHOJI, Susono-shi (JP); Noritsugu SAKUMA, Mishima-shi (JP); Akihito KINOSHITA, Mishima-shi (JP)

(73) Assignee: TOYOTA JIDOSHA KABUSHIKI KAISHA, Toyota-shi (JP)

(21) Appl. No.: 18/631,689

(22) Filed: Apr. 10, 2024

(30) Foreign Application Priority Data
Apr. 18, 2023 (JP) 2023-067750

(51) Int. Cl. H01F 1/059

(52) U.S. Cl. CPC H01F 1/0596

(57) ABSTRACT

A Sm—Fe—N-based magnetic material capable of enhancing saturation magnetization while suppressing a decrease in the anisotropic magnetic field as much as possible even when the use amount of Sm is reduced, and a production method thereof, are provided.

The magnetic material of the present disclosure includes a main phase having a predetermined crystal structure. The composition of the main phase is represented by (Sm_{(1-x-y-z)}LaₓCe_{y}R¹_{z})₂(Fe_{(1-p-q-s)}CoₚNi_{q}Mₛ)₁₇Nₕ, where R¹ is a given rare earth element, etc. M is a given element, and 0.25≤x+y≤0.73, 0.25≤x≤0.73, x/(x+y)≥0.80, 0≤z≤0.10, 0.10≤p+q≤0.53, p+q≥1.45(x+y)−0.5485, 0≤s≤0.10 and 2.9≤h≤3.3 are satisfied. The production method of the present disclosure includes nitriding a precursor including a crystal phase having a composition represented by (Sm_{(1-x-y-z)}LaₓCe_{y}R¹_{z})₂(Fe_{(1-p-q-s)}CoₚNi_{q}Mₛ)₁₇.

### FIELD

The present disclosure relates to a Sm—Fe—N-based magnetic material and a production method thereof. More specifically, the present disclosure relates to a Sm—Fe—N-based magnetic material including a main phase having a crystal structure of at least either Th₂Zn₁₇ type or Th₂Ni₁₇ type, and a production method thereof.

### BACKGROUND

As a high-performance magnetic material, a Sm—Co-based magnetic material and a Nd—Fe—B-based magnetic material have been put into practical use, but recently, magnetic materials other than these have been studied. For example, a Sm—Fe—N-based magnetic material including a main phase having a crystal structure of at least either Th₂Zn₁₇ type or Th₂Ni₁₇ type (hereinafter, sometimes simply referred to as “Sm—Fe—N-based magnetic material”) is being studied.

The Sm—Fe—N-based magnetic material includes a main phase having a crystal structure of at least either Th₂Zn₁₇ type or Th₂Ni₁₇ type. In this main phase, nitrogen is considered to be interstitially incorporated into a Sm—Fe-based crystal phase.

For example, PTL 1 discloses a manufacturing method of a Sm—Fe—N-based magnetic material, in which an oxide containing Sm Fe, La and W is reduced and the reduced product is nitrided to obtain a Sm—Fe—N-based magnetic material.

Also, PTL 2 and PTL 3 disclose a Sm—Fe—N-based magnetic material containing, as rare earth elements, a light rare earth element, in addition to Sm, and a production method thereof.

### CITATION LIST

### Patent Literature

[PTL 1] JP 2017-117937 A
[PTL 2] JP 2022-53187 A
[PTL 3] JP 2022-53207 A

### SUMMARY

### Technical Problem

Magnetic properties of the Sm—Fe—N-based magnetic material, particularly, saturation magnetization, are achieved by selecting Sm as a rare earth element. With the widespread use of the Sm—Fe—N-based magnetic material, the price of Sm that is a main element of the Sm—Fe—N-based magnetic material is expected to rise suddenly. Therefore, attempts have conventionally been made to substitute part of Sm with a rare earth element other than Sm, particularly a light rare earth element that is lower in rarity than Sm.

In the Sm—Fe—N-based magnetic material of PTL1, substitution of part of Sm with La is attempted, but due to a small substitution amount with La, a limited reduction in the use amount of Sm was allowed. In the Sm—Fe—N-based magnetic material of PTL2, the use amount of Sm is reduced by substituting part of Sm with La and/or Ce, but high saturation magnetization was not achieved, leaving a problem of decrease in the anisotropic magnetic field. In the Sm—Fe—N-based magnetic material of PTL3, high saturation magnetization was achieved by substituting part of Sm with La and/or Ce, but due to a small substitution amount with La and/or Ce, a limited reduction in the use amount of Sm was allowed.

These lead the present inventors to find a problem of requirement for a Sm—Fe—N-based magnetic material capable of enhancing the saturation magnetization while suppressing a decrease in the anisotropic magnetic field as much as possible even when the use amount of Sm is reduced, and a production method thereof.

The present disclosure has been made to solve the problem above. More specifically, an object of the present disclosure is to provide a Sm—Fe—N-based magnetic material capable of enhancing the saturation magnetization while suppressing a decrease in the anisotropic magnetic field as much as possible even when the use amount of Sm is reduced, and a production method thereof.

### Solution to Problem

The present inventors have made many intensive studies to attain the object above and have accomplished the Sm—Fe—N-based magnetic material of the present disclosure and a production method thereof. The Sm—Fe—N-based magnetic material of the present disclosure and a production method thereof include the following embodiments.

<1> A Sm—Fe—N-based magnetic material comprising a main phase having a crystal structure of at least either Th₂Zn₁₇ type or Th₂Ni₁₇ type, wherein
the composition of the main phase is represented by the molar ratio formula (Sm_{(1-x-y-z)}LaₓCe_{y}R¹_{z})₂(Fe_{(1-p-q-s)}CoₚNi_{q}Mₛ)₁₇Nₕ, where
R¹ is one or more rare earth elements other than Sm, La and Ce, and Zr,
M is one or more elements other than Fe, Co, Ni and rare earth elements, and unavoidable impurity elements, and
0.25≤x+y≤0.73,
0.25≤x≤0.73,
x/(x+y)≥0.80,
0≤z≤0.10,
0.10≤p+q≤0.53,
p+q≥1.45(x+y)−0.5485,
0≤s≤0.10 and
2.9≤h≤3.3 are satisfied.

<2> The Sm—Fe—N-based magnetic material according to <1>, wherein p and q satisfy 0.22≤p+q≤0.53.

<3> The Sm—Fe—N-based magnetic material according to <1> or <2>, wherein the lattice constant of the main phase is from 1.4350 to 1.4460.

<4> The Sm—Fe—N-based magnetic material according to <1> or <2>, wherein the lattice volume of the main phase is from 0.829 to 0.838 nm.

<5> The Sm—Fe—N-based magnetic material according to <1> or <2>, wherein the volume fraction of the main phase is from 80 to 100%.

<6> The Sm—Fe—N-based magnetic material according to <1> or <2>, wherein the density of the main phase is from 7.40 to 7.76 g/cm³.

<7> A production method of the Sm—Fe—N-based magnetic material according to <1> comprising:
preparing a magnetic material precursor having a crystal phase represented by the molar ratio formula (Sm_{(1-x-y-z)}LaₓCe_{y}R¹_{z})₂(Fe_{(1-p-q-s)}CoₚNi_{q}Mₛ)₁₇, where R¹ is one or more rare earth elements other than Sm, La and Ce, and Zr, M is one or more elements other than Fe, Co, Ni and rare earth elements, and unavoidable impurity elements, and 0.25≤x+y≤0.73, 0.25≤x≤0.73, x/(x+y)≥0.80, 0≤z≤0.10, 0.10≤p+q≤0.53, p+q≥1.45(x+y)−0.5485 and 0≤s≤0.10 are satisfied, and
nitriding the magnetic material precursor.

<8> The production method of the Sm—Fe—N-based magnetic according to <7>, wherein p and q satisfy 0.22≤p+q≤0.53.

<9> The production method of the Sm—Fe—N-based magnetic material according to <7> or <8>, wherein the magnetic material precursor is pulverized to obtain a magnetic material precursor powder and the magnetic material precursor powder is nitrided.

<10> The production method of the Sm—Fe—N-based magnetic material according to <7> or <8>, wherein raw materials containing elements constituting the magnetic material precursor are melted and solidified to obtain the magnetic material precursor.

### Advantageous Effects of Invention

According to the present disclosure, a Sm—Fe—N-based magnetic material where even when Sm is substituted with La in a predetermined ratio so as to reduce the use amount of Sm, since Fe is substituted with Co in a predetermined ratio, the saturation magnetization can be enhanced while suppressing a decrease in the anisotropic magnetic field as much as possible, can be provided.

In addition, according to the present disclosure, a production method of a Sm—Fe—N-based magnetic material where even when Sm is substituted with La in a predetermined ratio so as to reduce the use amount of Sm, since a magnetic material precursor in which Fe is substituted with Co in a predetermined ratio is nitrided, the saturation magnetization can be enhanced while suppressing a decrease in the anisotropic magnetic field as much as possible, can be provided.

### BRIEF DESCRIPTION OF DRAWINGS

FIG. 1 is a graph illustrating the relationship between the molar ratio x of La and the molar ratio p of Co.

FIG. 2 is a graph illustrating the relationship between the lattice constant and the saturation magnetization Ms.

FIG. 3 is a graph illustrating the relationship between the total of the molar ratio x of La and the molar ratio y of Ce, and the anisotropic magnetic field Ha.

FIG. 4 is a graph illustrating the relationship between the molar ratio x of La and the saturation magnetization Ms when the molar ratio p of Co is 0.3.

### DESCRIPTION OF EMBODIMENTS

Embodiments of the Sm—Fe—N-based magnetic material of the present disclosure and the production method thereof are described in detail below. Note that the embodiments described below do not limit the Sm—Fe—N-based magnetic material of the present disclosure and the production method thereof

Although not bound by theory, the reason why a Sm—Fe—N-based magnetic material capable of enhancing the saturation magnetization while suppressing a decrease in the anisotropic magnetic field as much as possible even when the use amount of Sm is reduced, and a production method thereof can be provided, is described below.

As described above, the Sm—Fe—N-based magnetic material of the present disclosure includes a main phase having a crystal structure of at least either Th₂Zn₁₇ type or Th₂Ni₁₇ type. The main phase in the Sm—Fe—N-based magnetic material of the present disclosure is nitrided and thereby develops magnetism. In the case where the main phase having a crystal structure of at least either Th₂Zn₁₇ type or Th₂Ni₁₇ type is constituted by Sm, Fe and N, the most representative main phase composition is represented by Sm₂Fe₁₇N₃. Hereinafter, a phase having such a composition is sometimes referred to as a “Sm₂Fe₁₇N₃ phase”

The Sm₂Fe₁₇N₃ phase is obtained by nitriding a Sm₂Fe₁₇ phase, and the Sm₂Fe₁₇N₃ phase has a crystal structure in which nitrogen (N) is interstitially incorporated into the Sm₂Fe₁₇ phase. The lattice volume of the Sm₂Fe₁₇N₃ phase is about 0.838 nm³.

When part of Sm in the Sm₂Fe₁₇N₃ phase is substituted with La that is more inexpensive than Sm so as to reduce the use amount of Sm, the lattice volume of the main phase changes. The change in the lattice volume of the main phase is accompanied by a change in the magnetic properties, particularly the saturation magnetization.

Since the ionic radius of La is very large compared to the ionic radius of Sm, when part of Sm is substituted with La, basically, the lattice volume of the main phase increases. A too large substitution amount with La leads to an excessive increase in the lattice volume, making it difficult to maintain the crystal structure of at least either Th₂Zn₁₇ type or Th₂Ni₁₇ type. Therefore, part of Fe is substituted with Co and/or Ni having an ionic radius smaller than that of Fe, then, an increase in the lattice volume can be suppressed, as a result, the crystal structure of at least either Th₂Zn₁₇ type or Th₂Ni₁₇ type can be maintained.

When part of Sm is substituted with a light rare earth element such as Ce and La, the saturation magnetization and anisotropic magnetic field are generally decreased in proportion to the substitution amount. However, even if Sm is substituted with La in a predetermined ratio, as long as Fe is substituted with Co in a predetermined ratio, not only the crystal structure of at least either Th₂Zn₁₇ type or Th₂Ni₁₇ type can be maintained but also an improvement of magnetic properties is recognized. More specifically, the present inventors have found that even if Sm is substituted with La in a predetermined ratio, when Fe is substituted with Co in a predetermined ratio, beyond the expectation from the substitution amount with La, the saturation magnetization can be enhanced while suppressing a decrease in the anisotropic magnetic field as much as possible.

The constituent elements of the Sm—Fe—N-based magnetic material of the present disclosure and the manufacturing method thereof, which have been accomplished based on the above-described findings, etc., are described below.

### <<Sm—Fe—N-Based Magnetic Material>>

The Sm—Fe—N-based magnetic material of the present disclosure includes a main phase having a crystal structure of at least either Th₂Zn₁₇ type or Th₂Ni₁₇ type. The Sm—Fe—N-based magnetic material of the present disclosure develops magnetism due to the main phase. The main phase is described below.

### <Crystal Structure of Main Phase>

The main phase has a crystal structure of at least either Th₂Zn₁₇ type or Th₂Ni₁₇ type. The crystal structure of the main phase may include a TbCu₇-type crystal structure, etc., in addition to the structure described above. Here, Th is thorium, Zn is zinc, Ni is nickel, Tb is terbium, and Cu is copper. The crystal structure of the main phase can be identified by subjecting the Sm—Fe—N-based magnetic material, for example, to an X-ray diffraction analysis, etc.

The phase having the above-described crystal structure can be achieved by a combination (composition) of various elements, but the main phase in the Sm—Fe—N-based magnetic material of the present disclosure is achieved by a combination (composition) of the following elements. The composition of the main phase in the Sm—Fe—N-based magnetic material of the present disclosure is described below.

### <Composition of Main Phase>

The main phase has a composition represented by the molar ratio formula (Sm_{(1-x-y-z)}LaₓCe_{y}R¹_{z})₂(Fe_{(1-p-q-s)}CoₚNi_{q}Mₛ)₁₇Nₕ. In the composition formula above, Sm is samarium, La is lanthanum, Ce is cerium, Fe is iron, Co is cobalt, and Ni is nickel. R¹ is one or more rare earth elements other than Sm, La and Ce, and Zr, and M is one or more elements other than Fe, Co, Ni and rare earth elements, and unavoidable impurity elements. Here, Zr is zirconium. Also, in the formula above, for convenience of description, Sm_{(1-x-y)}LaₓCe_{y}R¹_{z} and Fe_{(1-p-q-s)}CoₚNi_{q}Mₛ are sometimes referred to as a rare earth site and an iron group site, respectively.

As can be understood from the formula above, the main phase contains 2 mols of one or more elements of the rare earth site, 17 mols of one or more elements of the iron group site, and h mols of nitrogen (N). More specifically, the phase having the above-described crystal structure is constituted by one or more elements of the rare earth site and one or more elements of the iron group site, and h mols of nitrogen (N) is interstitially incorporated into the phase. When the amount of nitrogen (N) incorporated is h mols (provided that h is from 2.9 to 3.1), the crystal structure described above can be maintained. Details of nitrogen (N) in the main phase are described later.

The rare earth site consists of Sm, La, Ce and R¹, and Sm, La, Ce and R¹ are present at a ratio of (1-x-y-z):x:y:z in terms of molar ratio. Since (1-x-y-z)+x+y+z=1, the ratio means that part of Sm is substituted with one or more elements selected from the group consisting of La, Ce and R¹.

The iron group site consists of Fe, Co, Ni and M, and Fe, Co, Ni and M are present at a ratio of (1-p-q-s):p:q:s in terms of the molar ratio. Since (1-p-q-s)+p+q+s=1, the ratio means that part of Fe is substituted with one or more elements selected from the group consisting of Co, Ni and M.

Each element constituting the formula above and the content ratio (molar ratio) thereof are described below.

### <Sm>

Sm is a main element constituting the above-described crystal structure together with Fe and N. Part of Sm is substituted with one or more elements selected from the group consisting of La, Ce and R¹. La, Ce and R are described below.

### <La>

La belongs to the so-called light rare earth elements and, compared with Sm, is abundant in reserve (resource amount) and inexpensive. Since the ionic radius of La is greatly larger than the ionic radius of Sm, when part of Sm is substituted with La, basically, the lattice volume of the main phase increases.

As described above, the ionic radius of La is greatly larger than the ionic radius of Sm. Therefore, when part of Sm is substituted with La, this significantly affects the change in the lattice volume of the main phase. If the substitution amount with La is too large, it becomes difficult for the main phase to maintain the crystal structure of at least either Th₂Zn₁₇ type or Th₂Ni₁₇ type. Therefore, part of Fe is substituted with Co and/or Ni having an ionic radius smaller than that of Fe, then, an increase in the lattice volume can be suppressed, as a result, the main phase can maintain the crystal structure of at least either Th₂Zn₁₇ type or Th₂Ni₁₇ type. The substitution ratio when substituting part of Sm with La, and the substitution ratio when substituting part of Fe with Co are described later.

### <Ce>

Ce belongs to the so-called light rare earth elements and, compared with Sm, is abundant in reserve (resource amount) and inexpensive. Since the ionic radius of Ce is slightly larger than the ionic radius of Sm, when part of Sm is substituted with Ce, basically, the lattice volume of the main phase increases. However, Ce ions can be, for example, in its trivalent or tetravalent state, and therefore when part of Sm is substituted with Ce, the lattice volume of the main phase may increase or may decrease.

As described above, the ionic radius of Ce is slightly larger than the ionic radius of Sm. Consequently, even when part of Sm is substituted with Ce, the influence exerted on the change in the lattice volume of the main phase is small and in turn, the influence exerted on the saturation magnetization and anisotropic magnetic field is small. Therefore, the Sm—Fe—N-based magnetic material may optionally contain Ce. Since La significantly affects the change in the lattice volume of the main phase as described above, substituting part of Sm with La and substituting part of Fe with Co must be performed concurrently, and in addition, since the substitution ratio of La has an upper limit, part of Sm may optionally be substituted with Ce so as to increase the reduction amount of Sm.

### <R¹>

R is one or more rare earth elements other than Sm, La and Ce, and Zr. R is one or more elements that the Sm—Fe—N-based magnetic material of the present disclosure is allowed to contain within a range not impairing its magnetic properties. R¹ is typically one or more rare earth elements other than Sm, La and Ce, which are difficult to completely separate from each of Sm, La and Ce when purifying respective raw materials containing these elements and remain in a small amount in the raw material, etc. In addition to such rare earth elements, R¹ may contain Zr. Zr is not a rare earth element, but part of Sm is sometimes substituted with Zr. Even when part of Sm is substituted with Zr, as long as its substitution amount is small, the magnetic properties of the Sm—Fe—N-based magnetic material are not significantly impaired.

In the present description, unless otherwise indicated, the rare earth elements include 17 elements of Sc (scandium), Y (yttrium), La (lanthanum), Ce (cerium), Pr (praseodymium), Nd (neodymium), Pm (promethium), Sm (samarium), Eu (europium), Gd (gadolinium), Tb (terbium), Dy (dysprosium), Ho (holmium), Er (erbium), Tm (thulium), Yb (ytterbium) and Lu (ruthenium). Among these, unless otherwise indicated, Sc, Y, La and Ce are light rare earth elements. In addition, unless otherwise indicated, Pr, Nd, Pm, Sm and Eu are medium rare earth elements. Furthermore, unless otherwise indicated, Gd, Tb, Dy, Ho, Er, Tm, Yb and Lu are heavy rare earth elements. In general, the rarity of the heavy rare earth element is high, and the rarity of the light rare earth element is low. The rarity of the medium rare earth element is between the heavy rare earth element and the light rare earth element.

### <Fe>

Fe is a main element constituting the above-described crystal structure together with Sm and N. Part of Fe needs to be substituted with one or more elements selected from the group consisting of Co and Ni and furthermore, may be substituted with M. Co, Ni and M are described below.

### <Co>

Part of Fe is substituted with Co and/or Ni and is preferably substituted with Co. Co belongs to the so-called iron group elements, and the ionic radius of Co is smaller than the ionic radius of Fe. Since the lattice volume of the main phase basically increases when part of Sm is substituted with La, an excessive increase in the lattice volume of the main phase can be suppressed by substituting part of Fe with Co.

When part of Fe is substituted with Co, this is advantageous in that the Curie temperature of the main phase rises and a decrease in the saturation magnetization at a high temperature (from 403 to 473 K) can be suppressed.

### <Ni>

Part of Fe is substituted with Co and/or Ni. Ni belongs to the so-called iron group elements, and the ionic radius of Ni is smaller than the ionic radius of Fe. Since the lattice volume of the main phase basically increases when part of Sm is substituted with La, an excessive increase in the lattice volume of the main phase can be suppressed by substituting part of Fe with Ni.

Substituting part of Fe with Ni raises concerns of a decrease in the magnetic properties. However, since the ionic radius of Ni is smaller than the ionic radius of Co, in the case of substituting part of Fe with Ni, compared to substituting part of Fe with Co, the lattice volume of the main phase significantly decreases despite not so increasing the Ni substitution rate. Therefore, for example, when part of Sm is substituted with a large amount of La and the lattice volume of the main phase is excessively increased, the lattice volume of the main phase can be advantageously controlled by using a relatively small amount of Ni. Consequently, substituting part of Fe with Ni contributes to, rather than deteriorating the magnetic properties, controlling the lattice volume of the main phase and thereby stably maintaining the crystal structure of at least either Th₂Zn₁₇ type or Th₂Ni₁₇ type. In turn, the substitution contributes to improving the saturation magnetization while suppressing a decrease in the anisotropic magnetic field as much as possible even when the use amount of Sm is reduced by substituting part of Sm with La.

### <M>

M is one or more elements other than Fe, Co, Ni and rare earth elements, and unavoidable impurity elements. M is one or more elements and unavoidable impurity elements which the Sm—Fe—N-based magnetic material of the present disclosure is allowed to contain within a range not impairing its magnetic properties. The unavoidable impurity elements refer to impurity elements that are inevitably included at the time of production, etc. of the Sm—Fe—N-based magnetic material of the present disclosure or cause a significant rise in the production cost for avoiding its inclusion. Such an unavoidable impurity element includes impurity elements in raw materials, or elements, for example, an element in a bond, which undergoes diffusion and/or intrusion, etc. on the surface, etc. of the main phase at the time of forming, etc. of a bonded molded body, such as Cu (copper), Zn (zinc), Ga (gallium), Al (aluminum) and B (boron). In addition, the unavoidable elements include elements contained in a lubricant, etc. used at the time of molding, which are an element having diffused and/or intruded on the surface, etc. of the main phase.

M excluding the unavoidable impurity elements includes, for example, one or more elements selected from the group consisting of Ti (titanium), Cr (chromium), Mn (manganese), V (vanadium), Mo (molybdenum), W (tungsten) and C (carbon). These elements form, for example, a nuclear material at the time of creating the main phase and thereby contribute to promoting miniaturization of the main phase and/or suppressing grain growth of the main phase.

Furthermore, Zr may be contained as M. As described above, Zr is not a rare earth element, but part of Sm is substituted with Zr in some cases and on the other hand, part of Fe is substituted with Zr in some cases. In any case, as long as the substitution amount is small, the magnetic properties of the Sm—Fe—N-based magnetic material are not significantly impaired.

### <N>

N is interstitially incorporated into the main phase having the above-described crystal structure. N is incorporated to such an extent that N does not break the phase having the above-described crystal structure, and a magnetic moment thereby develops in the main phase.

In the Sm—Fe—N-based magnetic material of the present disclosure, part of Sm is mandatorily substituted with La and optionally substituted with Ce, and part of Fe is substituted with Co and/or Ni, preferably with Co. This is described below using the molar ratio formula (Sm_{(1-x-y-z)}LaₓCe_{y}R¹_{z})₂(Fe_{(1-p-q-s)}CoₚNi_{q}Mₛ)₁₇Nₕ representing the composition of the main phase.

<x+y>

In the formula above representing the composition of the main phase, the value of x indicates the ratio (molar ratio) in which part of Sm is substituted with La, and the value of y indicates the ratio (molar ratio) in which part of Sm is substituted with Ce.

When the value of x+y is 0.25 or more, an improvement in the economic efficiency due to substitution of part of Sm with inexpensive La and/or Ce can be substantially recognized. Also, when the value of x+y is 0.25 or more, enhancing the saturation magnetization while suppressing a decrease in the anisotropic magnetic field as much as possible is substantially recognized. From these points of view, the value of x+y may be 0.28 or more, 0.30 or more, 0.35 or more, 0.40 or more, 0.47 or more, 0.51 or more, or 0.55 or more. On the other hand, when the value of x+y is 0.73 or less, given that part of Fe is substituted with Co and/or Ni, the main phase can maintain the crystal structure of at least either Th₂Zn₁₇ type or Th₂Ni₁₇ type. From this viewpoint, the value of x+y may be 0.70 or less, 0.65 or less, or 0.58 or less.

In addition, while the value of x+y satisfies the range above, the value of x may be 0.25 or more, 0.28 or more, 0.30 or more, 0.35 or more, 0.40 or more, 0.47 or more, 0.48 or more, 0.51 or more, or 0.55 or more and may be 0.73 or less, 0.70 or less, 0.65 or less, or 0.58 or less. Similarly, while the value of x+y satisfies the range above, the value of y may be 0.26 or less, 0.24 or less, 0.22 or less, 0.20 or less, 0.19 or less, 0.18 or less, 0.16 or less, 0.14 or less, 0.12 or less, 0.10 or less, or 0.05 or less and may even be 0. y being 0 means that Ce is not contained on purpose and that the presence of Ce cannot be practically measured.

<Relationship Between x and x+y>

When part of Sm is mandatorily substituted with La and optionally substituted with Ce, for enhancing the saturation magnetization while suppressing a decrease in the anisotropic magnetic field as much as possible, the ratio of La is preferably higher. For this reason, x/(x+y) may be 0.80 or more, 0.82 or more, 0.85 or more, 0.90 or more, or 0.95 or more and may even be 1. x/(x+y) being 1 means that y is 0, namely, Ce is not contained on purpose, and that the presence of Ce cannot be practically measured.

<z>

In the formula above representing the composition of the main phase, z indicates the ratio (molar ratio) in which part of Sm is substituted with R¹. As described above, R¹ is one or more rare earth elements and Zr that the Sm—Fe—N-based magnetic material of the present disclosure is allowed to contain within a range not impairing its magnetic properties. In view of this, z may be 0.10 or less, 0.08 or less, 0.06 or less, 0.04 or less, or 0.02 or less. On the other hand, the Sm—Fe—N-based magnetic material of the present disclosure may not contain R¹ at all, that is, z may be 0, but it is difficult for the raw materials to be freed from R¹ at the time of producing the Sm—Fe—N-based magnetic material of the present disclosure. From this viewpoint, z may be 0.01 or more.

<p+q>

In the formula above representing the composition of the main phase, the value of p indicates the ratio (molar ratio) in which part of Fe is substituted with Co, and the value of q indicates the ratio (molar ratio) in which part of Fe is substituted with Ni.

In the case where part of Sm is substituted with a small amount of La and/or Ce, even if part of Fe is not substituted with Co and/or Ni, namely, the value of p+q is 0, the crystal structure of at least either Th₂Zn₁₇ type or Th₂Ni₁₇ type can be maintained.

However, when part of Sm is mandatorily substituted with La and optionally with Ce so as to greatly reduce the use amount of Sm as in the Sm—Fe—N-based magnetic material of the present invention, the substitution amount is large and, basically, the lattice volume of the main phase increases. Therefore, part of Fe is substituted with Co and/or Ni, and the crystal structure of at least either Th₂Zn₁₇ type or Th₂Ni₁₇ type is thereby maintained.

When the value of p+q is 0.10 or more, the crystal structure of at least either Th₂Zn₁₇ type or Th₂Ni₁₇ type can be maintained. From this viewpoint, the value of p+q may be may be 0.15 or more, 0.20 or more, 0.22 or more, or 0.30 or more. On the other hand, although Co and Ni are more expensive than Fe, when the value of p+q is 0.53 or less, the improvement in economic efficiency due to substituting part of Sm with inexpensive La and/or Ce is not offset. From this viewpoint, the value of p+q may be 0.50 or less, 0.45 or less, 0.40 or less, 0.35 or less, or 0.33 or less.

Furthermore, while the value of p+q satisfies the range above, the value of p may be 0.10 or more, 0.15 or more, 0.20 or more, 0.22 or more, or 0.30 or more and may be 0.53 or less, 0.50 or less, 0.45 or less, 0.40 or less, 0.35 or less, or 0.33 or less. Similarly, while the value of p+q satisfies the range above, the value of q may be 0.20 or less, 0.15 or less, 0.10 or less, 0.08 or less, 0.06 or less, 0.04 or less, or 0.02 or less and may even be 0. q being 0 means that Ni is not contained on purpose and that the presence of Ni cannot be practically measured.

<Relationship Between x+y and p+q>

x+y and p+q satisfy the relationship of p+q≥1.45(x+y)−0.5485. When this relationship is satisfied, the crystal structure of at least either Th₂Zn₁₇ type or Th₂Ni₁₇ type is maintained, and the saturation magnetization is enhanced while suppressing a decrease in the anisotropic magnetic field as much as possible.

As described above, when part of Sm is substituted with La or Ce and part of Fe is substituted with Co or Ni, with respect to enhancing the saturation magnetization while suppressing a decrease in the anisotropic magnetic field as much as possible, the influence of La and Co is large. Therefore, in the relationship of p+q≥1.45(x+y)−0.5485, roughly, q and y may be approximated to 0, and a relationship of p≥1.45x−0.5485 is considered to be approximately satisfied. According to this relationship, since the value of x indicates the ratio (molar ratio) in which part of Sm is substituted with La and the value of p indicates the ratio (molar ratio) in which part of Fe is substituted with Co, the effect of substitution with La can be considered to be 1.45 times the effect of substitution with Co.

<s>

In the formula above representing the composition of the main phase, s indicates the ratio (molar ratio) in which part of Fe is substituted with M. As described above, M is one or more elements and unavoidable impurity elements that the Sm—Fe—N-based magnetic material of the present disclosure is allowed to contain within a range not impairing its magnetic properties. Therefore, s may be 0.10 or less, 0.08 or less, 0.06 or less, 0.04 or less, or 0.02 or less. On the other hand, the Sm—Fe—N-based magnetic material of the present disclosure may not contain M at all, namely, s may be 0, but out of M, it is difficult for unavoidable impurity elements not to be contained at all. From this viewpoint, s may be 0.01 or more.

<h>

Next, h that indicates the degree of nitriding is described. When a Sm₂Fe₁₇ phase is nitrided, basically, a Sm₂Fe₁₇Nₕ phase (where, h=3) is formed. Nitriding is typically performed by exposing a Sm—Fe—N-based magnetic material precursor (hereinafter, sometimes simply referred to as “precursor”) having a Sm₂Fe₁₇ phase at a high temperature in a nitrogen gas atmosphere. Because of this, for example, the degree of nitriding differs between the surface and the inside of the precursor and, consequently, h can fluctuate within a range of 2.9 to 3.3. The same applies to the case where in the precursor, part of Sm is substituted with La and/or Ce and part of Fe is substituted with Co and/or Ni. More specifically, when a (Sm, La, Ce)₂(Fe, Co, Ni)₁₇ phase is nitrided, a (Sm, La, Ce)₂(Fe, Co, Ni)₁₇Nₕ phase (where, h is from 2.9 to 3.3) is formed.

When the main phase of the Sm—Fe—N-based magnetic material has the composition described hereinabove and furthermore, the lattice volume, lattice constant, volume fraction and density are as described below, the saturation magnetization is, in a more stable manner, enhanced while suppressing a decrease in the anisotropic magnetic field as much as possible. In the following, the lattice volume, lattice constant, volume fraction and density are described.

### <Lattice Volume>

The lattice volume of the main phase is preferably from 0.829 to 0.838 nm³. When the lattice volume of the main phase is in this range, it becomes easy to maintain the crystal structure of at least either Th₂Zn₁₇ type or Th₂Ni₁₇ type.

As described above, the saturation magnetization is derived from the magnetic moment development caused in the main phase by interstitial incorporation of N into the main phase. Therefore, the saturation magnetization is greatly affected by the distance between Fe and N in a lattice of the main phase (hereinafter, sometimes simply referred to as “Fe-to-N distance”). Since Fe and N are three-dimensionally arranged in a lattice of the main phase, the lattice volume of the main phase is convenient for grasping the Fe-to-N distance.

In the Sm—Fe—N-based magnetic material of the present disclosure, part of Sm is mandatorily substituted with La and optionally with Ce, and part of Fe is substituted with Co and/or Ni. The lattice volume of the Sm₂Fe₁₇N₃ phase is thereby changed. At this time, it is considered preferable to set the Fe-to-N distance in a lattice of the main phase close to the Fe-to-N distance in a lattice of the Sm₂Fe₁₇N₃ phase. Since the lattice volume of the Sm₂Fe₁₇N₃ phase is about 0.838 nm³, the lattice volume of the main phase in the Sm—Fe—N-based magnetic material of the present disclosure is considered to be preferably set close to 0.838 nm³. Then, in order to maintain the crystal structure of at least either Th₂Zn₁₇ type or Th₂Ni₁₇ type and enhance the saturation magnetization while suppressing a decrease in the anisotropic magnetic field as much as possible, the lattice volume of the main phase is preferably equal to or slightly smaller than the lattice volume of the Sm₂Fe₁₇N₃ phase. From these points of view, the lattice volume of the main phase may be 0.829 nm³ or more, 0.830 nm³ or more, 0.831 nm³ or more, 0.832 nm³ or more, 0.833 nm³ or more, or 0.834 nm³ or more and may be 0.838 nm³ or less, 0.837 nm³ or less, 0.836 nm³ or less, or 0.835 nm³ or less.

The lattice volume of the main phase can be determined in the following manner. The Sm—Fe—N-based magnetic material is subjected to X-ray diffraction analysis and, based on the relationship between the plane index and the lattice plane spacing value (d value), the a-axis length and the c-axis length are determined from the X-ray diffraction pattern. At the time of determining the a-axis length and the c-axis length, since the main phase of the Sm—Fe—N-based magnetic material of the present disclosure has the above-described crystal structure, the main phase may be assumed to be a rhombohedral crystal. Therefore, as the plane index, (202) plane, (113) plane, (104) plane, (211) plane, (122) plane and (300) plane can be used. Then, the lattice volume can be calculated according to the following formula.

$$( Lattice volume ) = {\{ ( a - axis length ) / 2 \}}^{2} \times 6 \times {3}^{0.5} \times \{ ( c - axis length ) / 3 \}$$

### <Lattice Constant>

The lattice constant of the main phase is preferably from 1.4350 to 1.4460. When the lattice constant of the main phase is in this range, the main phase is flat-shaped and not only the saturation magnetization is enhanced but also the decrease in the anisotropic magnetic field is smaller than that expected from the reduction in the use amount of Sm. From this viewpoint, the lattice constant of the main phase may be 1.4360 or more, 1.4370 or more, 1.4380 or more, 1.4390 or more, 1.4400 or more, 1.4410 or more, 1.4420 or more, or 1.4430 or more and may be 1.4459 or less, 1.4458 or less, or 1.4457 or less.

The lattice constant of the main phase can be determined in the following manner. The Sm—Fe—N-based magnetic material is subjected to X-ray diffraction analysis and, based on the relationship between the plane index and the lattice plane spacing value (d value), the a-axis length and the c-axis length are determined from the X-ray diffraction pattern. At the time of determining the a-axis length and the c-axis length, since the main phase of the Sm—Fe—N-based magnetic material of the present disclosure has the above-described crystal structure, the main phase may be assumed to be a rhombohedral crystal. Therefore, as the plane index, (202) plane, (113) plane, (104) plane, (211) plane, (122) plane and (300) plane can be used. Then, the lattice constant can be calculated according to the following formula.

Lattice constant (a/c)=(a—axis length)/(c—axis length)

### <Volume Fraction>

The Sm—Fe—N-based magnetic material of the present disclosure includes a main phase represented by the composition formula described above. The magnetic properties of the Sm—Fe—N-based magnetic material of the present disclosure are developed by the main phase. Therefore, the volume fraction of the main phase is preferably higher, relative to the entire Sm—Fe—N-based magnetic material of the present disclosure. Specifically, the volume fraction of the main phase may be, relative to the entire Sm—Fe—N-based magnetic material of the present disclosure, 80% or more, 81% or more, or 85% or more. On the other hand, the manufacture of the Sm—Fe—N-based magnetic material of the present disclosure sometimes involves, for example, a step of entering a temperature range where a phase other than the main phase represented by the composition formula above is stable. Also, it is sometimes difficult to be completely free from unavoidable impurity elements not constituting the main phase. From these points of view, although the volume fraction of the main phase is ideally 100%, as long as the above-described volume fraction of the main phase is ensured, there is no problem in practice even when the volume fraction of the main phase is 99% or less, 98% or less, 97% or less, 96% or less, or 95% or less.

The phase other than the main phase is typically present at grain boundaries between main phases, particularly at a triple point. The phase other than the main phase typically includes a SmFe₃ phase and its nitride phase, etc. The SmFe₃ phase and its nitride phase include a phase in which part of Sm is substituted with one or more elements selected from the group consisting of La, Ce and R¹, and its nitride phase, a phase in which part of Fe is substituted with one or more elements selected from the group consisting of Co, Ni and M, and its nitride phase, and a phase in which part of Sm is substituted with one or more elements selected from the group consisting of La, Ce and R¹ and part of Fe is substituted with one or more elements selected from the group consisting of Co, Ni and M, and their nitride phase.

As for the volume fraction of the main phase, the overall composition of the precursor before nitriding is measured using Inductively Coupled Plasma Atomic Emission Spectroscopy (ICP-AES) and, on the assumption that the precursor before nitriding is divided into a (Sm, La, Ce, R¹)₂(Fe, Co, Ni, M)₁₇ phase and a (Sm, La, Ce, R¹)(Fe, Co, Ni, M)₃ phase, the volume fraction of the main phase is calculated based on the measured values. Specifically, after a mass concentration (mass fraction) of each element is obtained from the ICP measurement results, a mass ratio of Sm₂Fe₁₇ phase and SmFe₃ phase is first calculated, and the volume fraction is calculated from the density of each phase. Note that the (Sm, La, Ce, R¹)₂(Fe, Co, Ni, M)₁₇ phase represents a Sm₂Fe₁₇ phase, a phase in which part of Sm in the Sm₂Fe₁₇ phase is substituted with one or more elements selected from the group consisting of Sm, La, Ce and R¹, a phase in which part of Fe in the Sm₂Fe₁₇ phase is substituted with one or more elements selected from the group consisting of Co, Ni and M, and a phase in which part of Sm in the Sm₂Fe₁₇ phase is substituted with one or more elements selected from the group consisting of Sm, La, Ce and R and part of Fe in the Sm₂Fe₁₇ phase is substituted with one or more elements selected from the group consisting of Co, Ni and M. Furthermore, the (Sm, La, Ce, R¹)(Fe, Co, Ni, M)₃ phase represents a SmFe₃ phase, a phase in which part of Sm in the SmFe₃ phase is substituted with one or more elements selected from the group consisting of Sm, La, Ce and R¹, a phase in which part of Fe in the SmFe₃ phase is substituted with one or more elements selected from the group consisting of Co, Ni and M, and a phase in which part of Sm in the SmFe₃ phase is substituted with one or more elements selected from the group consisting of Sm, La, Ce and R and part of Fe in the SmFe₃ phase is substituted with one or more elements selected from the group consisting of Co, Ni and M.

From the viewpoint of suppressing development of an α-(Fe, Co, Ni, M) phase and its nitride phase during manufacture of the Sm—Fe—N-based magnetic material of the present disclosure, the overall composition (the sum of the main phase and the phase other than the main phase) of the Sm—Fe—N-based magnetic material of the present disclosure can be set to be equal to or larger than the total number of moles of Sm, La, Ce and R of the main phase. That is, the overall composition of the Sm—Fe—N-based magnetic material of the present disclosure may be (Sm_{(1-x-y-z)}LaₓCe_{y}R¹_{z})_{w}(Fe_{(1-p-q-s)}CoₚNi_{q}Mₛ)₁₇Nₕ (where, w is from 2.00 to 3.00). At this time, x, y, z, p, q, s and h may be the same as x, y, z, p, q, s and h in the above-described formula representing the composition of the main phase. From the viewpoint of suppressing development of an α-(Fe, Co, Ni, M) phase, w is preferably 2.02 or more, 2.04 or more, 2.06 or more, 2.08 or more, 2.10 or more, 2.20 or more, 2.30 or more, 2.40 or more, or 2.50 or more. On the other hand, from the viewpoint of decreasing the volume fraction of the above-described (Sm, La, Ce, R¹)(Fe, Co, Ni, M)₃ phase, w is preferably 2.90 or less, 2.80 or less, 2.70 or less, or 2.60 or less.

### <Density of Main Phase>

The density of the main phase is preferably 7.40 g/cm³ or more, 7.45 g/cm³ or more, or 7.50 g/cm³ or more and is preferably 7.76 g/cm³ or less, 7.70 g/cm³ or less, or 7.65 g/cm³ or less. The density in this range of the main phase contributes to enhancing the saturation magnetization.

The density of the main phase is determined by pulverizing the Sm—Fe—N-based magnetic material to obtain powder and measuring the density of the powder by a pycnometer method. As described above, in the Sm—Fe—N-based magnetic material of the present disclosure, the volume fraction of the main phase is preferably 80%. Also, the densities of the Sm₂Fe₁₇N₃ phase and the SmFe₃ phase are 7.65 g/cm³ and 8.25 g/cm³, respectively, and are not so different. Therefore, the density of the main phase can be approximated by the value obtained by the measurement method above.

### <<Production Method>>

Next, the production method of the Sm—Fe—N-based magnetic material of the present disclosure (hereinafter, sometimes referred to as the “production method of the present disclosure”) is described.

The production method of the present disclosure includes a magnetic material precursor preparation step and a nitriding step. In the following, each step is described.

### <Magnetic Material Precursor Preparation Step>

In the production method of the present disclosure, a magnetic material precursor including a crystal phase having a composition represented by the molar ratio formula (Sm_{(1-x-y-z)}LaₓCe_{y}R¹_{z})₂(Fe_{(1-p-q-s)}CoₚNi_{q}Mₛ)₁₇ is prepared.

In the formula representing the composition of the crystal phase, Sm, La, Ce, R¹, Fe, Co, Ni, M, x, y, z, p, q and s are as described in “<<Sm—Fe—N-Based Magnetic Material>>”.

The crystal phase of the magnetic material precursor has a crystal structure of at least either Th₂Zn₁₇ type or Th₂Ni₁₇ type. When the magnetic material precursor is nitrided, the crystal phase in the magnetic material precursor is nitrided to form the main phase of the Sm—Fe—N-based magnetic material of the present disclosure. The main phase of Sm—Fe—N-based magnetic material of the present disclosure has a crystal structure of at least either Th₂Zn₁₇ type or Th₂Ni₁₇ type. Therefore, nitriding is performed to such an extent as to maintain the crystal structure of at least either Th₂Zn₁₇ type or Th₂Ni₁₇ type, and a main phase having a lattice volume and a lattice constant in the above-described ranges can thereby be obtained.

As described above, since the main phase of the Sm—Fe—N-based magnetic material of the present disclosure is formed as a result of nitriding of the crystal phase in the magnetic material precursor, the volume fraction of the crystal phase in the magnetic material precursor may be considered to be equivalent to the volume fraction of the main phase in the Sm—Fe—N-based magnetic material of the present disclosure. Therefore, the volume fraction of the crystal phase of the magnetic material precursor may be, relative to the entire magnetic material precursor, 80% or more, 81% or more, or 85% or more. The production of the magnetic material precursor sometimes involves, for example, a step of entering a temperature range where a phase other than the crystal phase represented by the composition formula above is stable. Also, it is sometimes difficult to be completely free from unavoidable impurity elements not constituting the main phase. Although the volume fraction of the crystal phase is ideally 100%, as long as the above-described volume fraction of the crystal phase is ensured, there is no problem in practice even when the volume fraction of the crystal phase is 99% or less, 98% or less, 97% or less, 96% or less, or 95% or less.

The phase other than the crystal phase is typically present at grain boundaries between crystal phases, particularly at a triple point. The phase other than the crystal phase typically includes a SmFe₃ phase. The SmFe₃ phase includes a phase in which part of Sm is substituted with one or more elements selected from the group consisting of La, Ce and R¹, a phase in which part of Fe is substituted with one or more elements selected from the group consisting of Co, Ni and M, and a phase in which part of Sm is substituted with one or more elements selected from the group consisting of La, Ce and R and part of Fe is substituted with one or more elements selected from the group consisting of Co, Ni and M.

As for the volume fraction of the crystal phase, the overall composition of the precursor before nitriding is measured using Inductively Coupled Plasma Atomic Emission Spectroscopy (ICP-AES) and, on the assumption that the precursor before nitriding is divided into a (Sm, La, Ce, R¹)₂(Fe, Co, Ni, M)₁₇ phase and a (Sm, La, Ce, R¹)(Fe, Co, Ni, M)₃ phase, the volume fraction of the crystal phase is calculated based on the measured values. Specifically, after a mass concentration (mass fraction) of each element is obtained from the ICP measurement results, a mass ratio of Sm₂Fe₁₇ phase and SmFe₃ phase is first calculated, and the volume fraction is calculated from the density of each phase. Note that the (Sm, La, Ce, R¹)₂(Fe, Co, Ni, M)₁₇ phase represents a Sm₂Fe₁₇ phase, a phase in which part of Sm in the Sm₂Fe₁₇ phase is substituted with one or more elements selected from the group consisting of Sm, La, Ce and R a phase in which part of Fe in the Sm₂Fe₁₇ phase is substituted with one or more elements selected from the group consisting of Co, Ni and M, and a phase in which part of Sm in the Sm₂Fe₁₇ phase is substituted with one or more elements selected from the group consisting of Sm, La, Ce and R¹ and part of Fe in the Sm₂Fe₁₇ phase is substituted with one or more elements selected from the group consisting of Co, Ni and M. Also, the (Sm, La, Ce, R¹)(Fe, Co, Ni, M)₃ phase represents a SmFe₃ phase, a phase in which part of Sm in the SmFe₃ phase is substituted with one or more elements selected from the group consisting of Sm, La, Ce and R¹, a phase in which part of Fe in the SmFe₃ phase is substituted with one or more elements selected from the group consisting of Co, Ni and M, and a phase in which part of Sm in the SmFe₃ phase is substituted with one or more elements selected from the group consisting of Sm, La, Ce and R¹ and part of Fe in the SmFe₃ phase is substituted with one or more elements selected from the group consisting of Co, Ni and M.

From the viewpoint of suppressing development of an α-(Fe, Co, Ni, M) phase during production of the magnetic material precursor, the overall composition (the sum of the crystal phase and the phase other than the crystal phase) of the magnetic material precursor can be set to be equal to or larger than the total number of moles of Sm, La, Ce and R of the crystal phase. That is, the overall composition of the magnetic material precursor may be (Sm_{(1-x-y-z)}LaₓCe_{y}R¹_{z})_{w}(Fe_{(1-p-q-s)}CoₚNi_{q}Mₛ)₁₇ (where, w is from 2.00 to 3.00). At this time, x, y, z, p, q and s may be the same as x, y, z, p, q and s in the above-described formula representing the composition of the crystal phase. From the viewpoint of suppressing development of an α-(Fe, Co, Ni, M) phase, w is preferably 2.02 or more, 2.04 or more, 2.06 or more, 2.08 or more, 2.10 or more, 2.20 or more, 2.30 or more, 2.40 or more, or 2.50 or more. On the other hand, from the viewpoint of decreasing the volume fraction of the (Sm, La, Ce, R¹)(Fe, Co, Ni, M)₃ phase, w is preferably 2.90 or less, 2.80 or less, 2.70 or less, or 2.60 or less.

The magnetic material precursor can be obtained using a well-known production method. The method for obtaining the magnetic material precursor includes, for example, a method in which raw materials containing elements constituting the magnetic material precursor are melted and solidified. The method for melting the raw materials includes, for example, a method in which the raw materials are charged into a container such as crucible and after obtaining a molten metal by arc-melting or high-frequency melting of the raw materials in the container, the molten metal is poured into a mold such as book mold or the molten metal is solidified in the crucible. From the viewpoint of, e.g., suppressing coarsening of the crystal phase in the magnetic material precursor and homogenizing the crystal phase, it is preferable to increase the cooling rate of the molten metal. From this viewpoint, it is preferable to pour the molten metal into a mold such as book mold. Furthermore, from the viewpoint of, e.g., suppressing the coarsening of the crystal phase in the magnetic material precursor and homogenizing the crystal phase, for example, the following method may be employed. That is, an ingot obtained by high-frequency melting or arc-melting and subsequent solidification of the raw materials in a container is again melted by high-frequency melting, etc., the melt is quenched using a strip casting method, a liquid quenching method, etc. to obtain a flake, and the flake may be used as the magnetic material precursor.

Prior to the below-described nitriding, the magnetic material precursor may be subjected to a heat treatment so as to homogenize crystal grains in the magnetic material precursor (hereinafter, such a heat treatment is sometimes referred to as “homogenization heat treatment”). The temperature of the homogenization heat treatment may be, for example, 1273 K or more, 1323 K or more, or 1373 K or more and may be 1523 K or less, 1473 K or less, or 1423 K or less. The homogenization heat treatment time may be, for example, 6 hours or more, 12 hours or more, 18 hours or more, or 24 hours or more and may be 48 hours or less, 42 hours or less, 36 hours or less, or 30 hours or less.

In order to suppress oxidation of the magnetic material precursor, the homogenization heat treatment is preferably performed in an inert gas atmosphere. A nitrogen gas atmosphere is not encompassed by the inert gas atmosphere. This is because if the homogenization heat treatment is performed in a nitrogen gas atmosphere, the phase having Th₂Zn₁₇ type and/or Th₂Ni₁₇ type crystal structures is likely to decompose.

### <Nitriding Step>

The above-described magnetic material precursor is nitrided. The crystal phase in the magnetic material precursor is thereby nitrided to form the main phase of the Sm—Fe—N-based magnetic material of the present disclosure.

The nitriding method is not particularly limited as long as a desired main phase can be obtained but, typically, includes, for example, a method in which the magnetic material precursor is exposed, while being heated, to an atmosphere containing nitrogen gas or to a gas atmosphere containing nitrogen (N). The atmosphere containing nitrogen gas includes, for example, a nitrogen gas atmosphere, a mixed gas atmosphere of nitrogen gas and inert gas, and a mixed gas atmosphere of nitrogen gas and hydrogen gas. The gas atmosphere containing nitrogen (N) includes, for example, an ammonia gas atmosphere and a mixed gas atmosphere of ammonia gas and hydrogen gas. The atmospheres exemplified above may be combined. From the viewpoint of nitriding efficiency, an ammonia gas atmosphere, a mixed gas atmosphere of ammonia gas and hydrogen gas, and a mixed gas atmosphere of nitrogen gas and hydrogen gas are preferred.

After the magnetic material precursor is pulverized before nitriding to obtain a magnetic material precursor powder, the magnetic material precursor powder may be nitrided. By performing nitriding after pulverizing the magnetic material precursor, the crystal phase present inside the magnetic material precursor can be sufficiently nitrided. The pulverization of the magnetic material precursor is preferably performed in an inert gas atmosphere. The inert gas atmosphere may include a nitrogen gas atmosphere. This makes it possible to prevent oxidation of the magnetic material precursor from occurring during pulverization. The particle size of the magnetic material precursor powder may be, in terms of D₅₀, 5 μm or more, 10 μm or more, or 15 μm or more and may be 50 μm or less, 40 μm or less, 30 μm or less, 25 μm or less, or 20 μm or less.

The nitriding temperature may be, for example, 673 K or more, 698 K or more, 723 K or more, or 748 K or more and may be 823 K or less, 798 K or less, or 773 K or less. Also, the nitriding time may be, for example, 4 hours or more, 8 hours or more, 12 hours or more, or 16 hours or more and may be 48 hours or less, 36 hours or less, 24 hours or less, 20 hours or less, or 18 hours or less.

### <<Modification>>

The Sm—Fe—N-based magnetic material of the present disclosure and the production method thereof are not limited to the embodiments described so far and may be appropriately modified within the scope of the claims. For example, the Sm—Fe—N-based magnetic material of the present disclosure may be a powder or may be a molded body of the powder. The molded body may be a bonded molded body or may be a sintered molded body. In the case of a molded body, a bonded molded body is preferred for the reason that it is easy to avoid temperatures causing nitrogen (N) in the main phase to desorb (decompose) during the molding step. The bond includes, for example, a resin and a low melting point metal bond. The low melting point metal bond includes, for example, zinc metal, a zinc alloy, and a combination thereof.

### Examples

The Sm—Fe—N-based magnetic material of the present disclosure and the production method thereof are described more specifically below with reference to Examples and Comparative Examples. Note that the Sm—Fe—N-based magnetic material of the present disclosure and the production method thereof are not limited to the conditions used in the following Examples.

### <<Preparation of Sample>>

Samples of the Sm—Fe—N-based magnetic material were prepared in the following manner.

Sm metal, La metal, Ce metal, Fe metal, Co metal and Ni metal were mixed to allow the main phase to have the composition shown in Table 1, and the mixture was high-frequency melted at 1673 K (1,400° C.) and solidified to obtain a magnetic material precursor. At the time of mixing, the total number of moles of mixed Sm, La, and Ce was set larger than the total number of moles of Sm, La, and Ce in the main phase so that the volume fraction of the main phase can be from 80 to 100%. Here, in the present description, for example, “Sm metal” means Sm that is not alloyed. Needless to say, Sm metal, La metal, Ce metal, Fe metal, Co metal and Ni metal may contain unavoidable impurities.

The magnetic material precursor was subjected to a homogenization heat treatment in an argon gas atmosphere at 1373 K over 24 hours.

The magnetic material precursor after the homogenization heat treatment was charged into a glove box, and the magnetic material precursor was pulverized by means of a cutter mill in a nitrogen gas atmosphere. The particle size of the magnetic material precursor powder after the pulverization was 20 μm or less in terms of D₅₀.

In a nitrogen gas atmosphere, the magnetic material precursor powder was heated to 748 K and nitrided over 16 hours. The nitriding amount was determined by a change in mass of the magnetic material precursor powder before and after nitriding.

### <<Evaluation>>

The composition, lattice volume, lattice constant, density and volume fraction of the main phase were determined for each sample by the above-described measurement methods. Also, the magnetic properties of each sample were measured by applying a maximum magnetic field of 9 T using a Physical Properties Measurement System PPMS (registered trademark)-VSM. With respect to the measurement of the magnetic properties, each sample powder after nitriding was solidified while being magnetically oriented in an epoxy resin, and the magnetic properties of each sample after solidification were measured at 300 to 453 K in a magnetization easy axis direction and a magnetization hard axis direction. From the measured values in the magnetization easy axis direction, a saturation magnetization was calculated using the law of approach to saturation. Then, a saturation magnetization Ms was calculated by dividing the saturation magnetization determined using the law of approach to saturation by the volume fraction of the main phase. Furthermore, an anisotropic magnetic field Ha was determined from the intersection of a hysteresis curve in the magnetization easy axis direction with a hysteresis curve in the magnetization hard axis direction.

The results are shown in Table 1. In Table 1, “-” indicates that since the phase stability was poor, the crystal structure, density and volume fraction of the main phase, the saturation magnetization, and the anisotropic magnetic field could not be measured.

TABLE 1

| | | | Rare Earth Element Molar Ratio | | | |
|---|---|---|---|---|---|---|
| | | Phase | Sm | La | Ce | La + Ce |
| | Main Phase Composition (molar ratio) | Stability | l − x − y | x | y | x + y |
| Example 1 | (Sm0.42La0.48Ce0.1)2(Fe0.67Co0.33)17N3 | good | 0.42 | 0.48 | 0.10 | 0.58 |
| Example 2 | (Sm0.53La0.47)2(Fe0.7Co0.3)17N3 | good | 0.53 | 0.47 | 0.00 | 0.47 |
| Example 3 | (Sm0.72La0.28)2(Fe0.7Co0.3)17N3 | good | 0.72 | 0.28 | 0.00 | 0.28 |
| Example 4 | (Sm0.27La0.73)2(Fe0.47Co0.53)17N3 | good | 0.27 | 0.73 | 0.00 | 0.73 |
| Example 5 | (Sm0.49La0.51)2(Fe0.78Co0.22)17N3 | good | 0.49 | 0.51 | 0.00 | 0.51 |
| Example 6 | (Sm0.75La0.25)2(Fe0.9Co0.1)17N3 | good | 0.75 | 0.25 | 0.00 | 0.25 |
| Com. Ex. 1 | Sm2(Fe0.7Co0.3)17N3 | good | 1.00 | 0.00 | 0.00 | 0.00 |
| Com. Ex. 2 | (Sm0.9La0.1)2(Fe0.7Co0.3)17N3 | good | 0.90 | 0.10 | 0.00 | 0.10 |
| Com. Ex. 3 | (Sm0.79La0.21)2Fe17N3 | good | 0.79 | 0.21 | 0.00 | 0.21 |
| Com. Ex. 4 | (Sm0.79La0.21)2(Fe0.85Co0.15)17N3 | good | 0.79 | 0.21 | 0.00 | 0.21 |
| Com. Ex. 5 | (Sm0.8La0.2)2(Fe0.7Co0.3)17N3 | good | 0.80 | 0.20 | 0.00 | 0.20 |
| Com. Ex. 6 | (Sm0.21La0.79)2Co17N3 | good | 0.21 | 0.79 | 0.00 | 0.79 |
| Com. Ex. 7 | (Sm0.7La0.16Ce0.14)2(Fe0.71Co0.29)17N3 | good | 0.70 | 0.16 | 0.14 | 0.30 |
| Com. Ex. 8 | (Sm0.51La0.25Ce0.24)2(Fe0.71Co0.29)17N3 | good | 0.51 | 0.25 | 0.24 | 0.49 |
| Com. Ex. 9 | (Sm0.5Ce0.5)2Fe17N3 | good | 0.50 | 0.00 | 0.50 | 0.50 |
| Com. Ex. 10 | (Sm0.76Ce0.24)2Fe17N3 | good | 0.76 | 0.00 | 0.24 | 0.24 |
| Com. Ex. 11 | (Sm0.72Ce0.28)2(Fe0.72Co0.28)17N3 | good | 0.72 | 0.00 | 0.28 | 0.28 |
| Com. Ex. 12 | (Sm0.52Ce0.48)2(Fe0.71Co0.29)17N3 | good | 0.52 | 0.00 | 0.48 | 0.48 |
| Com. Ex. 13 | Sm2Co17N3 | good | 1.00 | 0.00 | 0.00 | 0.00 |
| Com. Ex. 14 | Sm2Fe17N3 | good | 1.00 | 0.00 | 0.00 | 0.00 |

| | Rare Earth | | | | |
|---|---|---|---|---|---|
| | Element Molar Ratio | Iron Group Element Molar Ratio | | | Nitrogen |
| | La/(Ce + La) | Fe | Co | Ni | Molar Ratio |
| | x(x + y) | l − p − q | p | q | h |
| Example 1 | 0.82 | 0.67 | 0.33 | 0.00 | 3.3 |
| Example 2 | 1.00 | 0.70 | 0.30 | 0.00 | 3.1 |
| Example 3 | 1.00 | 0.70 | 0.30 | 0.00 | 3.1 |
| Example 4 | 1.00 | 0.47 | 0.53 | 0.00 | 3.3 |
| Example 5 | 1.00 | 0.78 | 0.22 | 0.00 | 3.3 |
| Example 6 | 1.00 | 0.90 | 0.10 | 0.00 | 3.1 |
| Com. Ex. 1 | 0.00 | 0.70 | 0.30 | 0.00 | 2.8 |
| Com. Ex. 2 | 1.00 | 0.70 | 0.30 | 0.00 | 2.9 |
| Com. Ex. 3 | 1.00 | 1.00 | 0.00 | 0.00 | 3.0 |
| Com. Ex. 4 | 1.00 | 0.85 | 0.15 | 0.00 | 3.0 |
| Com. Ex. 5 | 1.00 | 0.70 | 0.30 | 0.00 | 2.9 |
| Com. Ex. 6 | 1.00 | 0.00 | 1.00 | 0.00 | 3.3 |
| Com. Ex. 7 | 0.53 | 0.71 | 0.29 | 0.00 | 3.2 |
| Com. Ex. 8 | 0.52 | 0.71 | 0.29 | 0.00 | 3.1 |
| Com. Ex. 9 | 0.00 | 1.00 | 0.00 | 0.00 | 3.2 |
| Com. Ex. 10 | 0.00 | 1.00 | 0.00 | 0.00 | 3.1 |
| Com. Ex. 11 | 0.00 | 0.72 | 0.28 | 0.00 | 3.1 |
| Com. Ex. 12 | 0.00 | 0.71 | 0.29 | 0.00 | 3.2 |
| Com. Ex. 13 | 0.00 | 0.00 | 1.00 | 0.00 | 2.5 |
| Com. Ex. 14 | 0.00 | 1.00 | 0.00 | 0.00 | 3.2 |

| | Crystal Structure of Main Phase | | | | |
|---|---|---|---|---|---|
| | a-Axis | c-Axis | Lattice | Lattice | Density of |
| | Length | Length | Volume | Constant | Main Phase |
| | (nm) | (nm) | (nm³) | c/a | (g/cm³) |
| Example 1 | 0.873 | 1.261 | 0.832 | 1.4442 | 7.63 |
| Example 2 | 0.872 | 1.259 | 0.829 | 1.4436 | 7.65 |
| Example 3 | 0.872 | 1.260 | 0.829 | 1.4455 | 7.75 |
| Example 4 | 0.874 | 1.256 | 0.831 | 1.4370 | 7.51 |
| Example 5 | 0.875 | 1.263 | 0.838 | 1.4431 | 7.40 |
| Example 6 | 0.874 | 1.264 | 0.836 | 1.4458 | 7.76 |
| Com. Ex. 1 | 0.870 | 1.263 | 0.828 | 1.4519 | 7.80 |
| Com. Ex. 2 | 0.871 | 1.262 | 0.828 | 1.4495 | 7.71 |
| Com. Ex. 3 | 0.876 | 1.267 | 0.843 | 1.4463 | 7.37 |
| Com. Ex. 4 | 0.874 | 1.264 | 0.836 | 1.4470 | 7.48 |
| Com. Ex. 3 | 0.872 | 1.263 | 0.831 | 1.4479 | 7.60 |
| Com. Ex. 6 | 0.867 | 1.243 | 0.810 | 1.4327 | 7.99 |
| Com. Ex. 7 | 0.871 | 1.261 | 0.828 | 1.4486 | 7.54 |
| Com. Ex. 8 | 0.871 | 1.261 | 0.829 | 1.4468 | 7.48 |
| Com. Ex. 9 | 0.874 | 1.266 | 0.838 | 1.4488 | 7.54 |
| Com. Ex. 10 | 0.874 | 1.266 | 0.838 | 1.4484 | 7.60 |
| Com. Ex. 11 | 0.870 | 1.263 | 0.827 | 1.4519 | 7.63 |
| Com. Ex. 12 | 0.869 | 1.262 | 0.825 | 1.4518 | 7.62 |
| Com. Ex. 13 | 0.857 | 1.240 | 0.789 | 1.4463 | 8.46 |
| Com. Ex. 14 | 0.875 | 1.268 | 0.840 | 1.4494 | 7.58 |

| | | |
|---|---|---|
| Volume Fraction | Saturation Magnetization Ms | Anisotropic Magnetic Field Ha |

| | of Main Phase | 453K | 300K | 453K | 300K |
|---|---|---|---|---|---|
| | (%) | (T) | (T) | (T) | (T) |
| Example 1 | 85.0 | 1.43 | 1.52 | 8.0 | 13.2 |
| Example 2 | 90.0 | 1.49 | 1.61 | 8.7 | 14.2 |
| Example 3 | 93.4 | 1.42 | 1.51 | 10.1 | 16.7 |
| Example 4 | 81.0 | 1.47 | 1.56 | 5.0 | 9.4 |
| Example 5 | 80.0 | 1.52 | 1.57 | 9.0 | 15.6 |
| Example 6 | 94.9 | 1.45 | 1.58 | 9.5 | 15.2 |
| Com. Ex. 1 | 95.0 | 1.34 | 1.43 | 11.6 | 17.0 |
| Com. Ex. 2 | 95.2 | 1.32 | 1.42 | 10.8 | 16.8 |
| Com. Ex. 3 | 96.2 | 1.31 | 1.45 | 8.0 | 14.5 |
| Com. Ex. 4 | 96.2 | 1.35 | 1.46 | 9.7 | 15.3 |
| Com. Ex. 3 | 94.4 | 1.32 | 1.41 | 10.8 | 16.5 |
| Com. Ex. 6 | 96.2 | 0.74 | 0.84 | 3.1 | 5.9 |
| Com. Ex. 7 | 94.6 | 1.38 | 1.47 | 9.7 | 14.2 |
| Com. Ex. 8 | 96.5 | 1.34 | 1.46 | 6.6 | 12.4 |
| Com. Ex. 9 | 99.4 | 1.33 | 1.50 | 4.9 | 10.3 |
| Com. Ex. 10 | 98.3 | 1.36 | 1.52 | 7.3 | 14.3 |
| Com. Ex. 11 | 98.4 | 1.33 | 1.43 | 9.2 | 14.3 |
| Com. Ex. 12 | 98.4 | 1.35 | 1.46 | 6.9 | 11.9 |
| Com. Ex. 13 | 94.3 | 1.11 | 1.18 | 6.5 | 13.6 |
| Com. Ex. 14 | 97.8 | 1.39 | 1.50 | 10.1 | 16.2 |

| | | | Rare Earth Element Molar Ratio | | | |
|---|---|---|---|---|---|---|
| | | Phase | Sm | La | Ce | La + Ce |
| | Main Phase Composition (molar ratio) | Stability | l − x − y | x | y | x + y |
| Com. Ex. 15 | La2(Fe0.59Co0.41)17N3 | poor | 0.00 | 1.00 | 0.00 | 1.00 |
| Com. Ex. 16 | Ce2Fe17N3 | poor | 0.00 | 0.00 | 1.00 | 1.00 |
| Com. Ex. 17 | (Ce0.54La0.46)2(Fe0.48Co0.52)17N3 | poor | 0.00 | 0.46 | 0.54 | 1.00 |
| Com. Ex. 18 | (Sm0.56La0.44)2(Fe0.89Co0.11)17N3 | poor | 0.56 | 0.44 | 0.00 | 0.44 |
| Com. Ex. 19 | (Sm0.27La0.73)2(Fe0.54Co0.46)17N3 | poor | 0.27 | 0.73 | 0.00 | 0.73 |
| Com. Ex. 20 | (Sm0.19La0.38Ce0.43)2(Fe0.73Co0.27)17N3 | poor | 0.19 | 0.38 | 0.43 | 0.81 |
| Com. Ex. 21 | La2(Fe0.42Co0.58)17N3 | poor | 0.00 | 1.00 | 0.00 | 1.00 |
| Com. Ex. 22 | (Sm0.25Ce0.45La0.3)2Fe17N3 | poor | 0.25 | 0.31 | 0.45 | 0.75 |
| Com. Ex. 23 | (Ce0.82La0.18)2Fe17N3 | poor | 0.00 | 0.18 | 0.82 | 1.00 |
| Com. Ex. 24 | (Ce0.61La0.39)2Fe17N3 | poor | 0.00 | 0.39 | 0.61 | 1.00 |
| Com. Ex. 25 | (Sm0.2Ce0.65La0.15)2Fe17N3 | poor | 0.20 | 0.15 | 0.65 | 0.80 |
| Com. Ex. 26 | (Ce0.54La0.46)2(Fe0.85Co0.15)17N3 | poor | 0.00 | 0.46 | 0.54 | 1.00 |
| Com. Ex. 27 | La2(Fe0.66Co0.34)17N3 | poor | 0.00 | 1.00 | 0.00 | 1.00 |
| Com. Ex. 28 | Ce2Fe17N3 | poor | 0.00 | 0.00 | 1.00 | 1.00 |
| Com. Ex. 29 | (Ce0.53La0.47)2(Fe0.57Co0.43)17N3 | poor | 0.00 | 0.47 | 0.53 | 1.00 |
| Com. Ex. 30 | (Sm0.21La0.79)2(Fe0.2Co0.8)17N3 | poor | 0.21 | 0.79 | 0.00 | 0.79 |
| Com. Ex. 31 | (Sm0.25La0.75)2(Fe0.6Co0.2Ni0.2)17N3 | poor | 0.23 | 0.77 | 0.00 | 0.77 |
| Com. Ex. 32 | La2Co17N3 | poor | 0.00 | 1.00 | 0.00 | 1.00 |
| Com. Ex. 33 | (Sm0.7La0.3)2Fe17N3 | poor | 0.70 | 0.30 | 0.00 | 1.00 |

| | Rare Earth | | | | |
|---|---|---|---|---|---|
| | Element Molar Ratio | Iron Group Element Molar Ratio | | | Nitrogen |
| | La/(Ce + La) | Fe | Co | Ni | Molar Ratio |
| | x(x + y) | l − p − q | p | q | h |
| Com. Ex. 15 | 1.00 | 0.59 | 0.41 | 0.00 | 3.1 |
| Com. Ex. 16 | 0.00 | 1.00 | 0.00 | 0.00 | 3.7 |
| Com. Ex. 17 | 0.46 | 0.48 | 0.52 | 0.00 | 4.0 |
| Com. Ex. 18 | 1.00 | 0.89 | 0.11 | 0.00 | 2.8 |
| Com. Ex. 19 | 1.00 | 0.54 | 0.46 | 0.00 | 3.2 |
| Com. Ex. 20 | 0.47 | 0.73 | 0.27 | 0.00 | 3.2 |
| Com. Ex. 21 | 1.00 | 0.42 | 0.58 | 0.00 | 4.4 |
| Com. Ex. 22 | 0.41 | 1.00 | 0.00 | 0.00 | 2.8 |
| Com. Ex. 23 | 0.18 | 1.00 | 0.00 | 0.00 | 3.3 |
| Com. Ex. 24 | 0.39 | 1.00 | 0.00 | 0.00 | 2.5 |
| Com. Ex. 25 | 0.19 | 1.00 | 0.00 | 0.00 | 2.8 |
| Com. Ex. 26 | 0.46 | 0.85 | 0.15 | 0.00 | 2.7 |
| Com. Ex. 27 | 1.00 | 0.66 | 0.34 | 0.00 | 2.6 |
| Com. Ex. 28 | 0.00 | 1.00 | 0.00 | 0.00 | 2.9 |
| Com. Ex. 29 | 0.47 | 0.57 | 0.43 | 0.00 | 3.3 |
| Com. Ex. 30 | 1.00 | 0.66 | 0.34 | 0.00 | 3.4 |
| Com. Ex. 31 | 1.00 | 0.27 | 0.16 | 0.57 | 3.7 |
| Com. Ex. 32 | 1.00 | 1.00 | 0.00 | 0.00 | 3.8 |
| Com. Ex. 33 | 0.30 | 1.00 | 0.00 | 0.00 | 3.0 |

| | Crystal Structure of Main Phase | | | | |
|---|---|---|---|---|---|
| | a-Axis | c-Axis | Lattice | Lattice | Density of |
| | Length | Length | Volume | Constant | Main Phase |
| | (nm) | (nm) | (nm³) | c/a | (g/cm³) |
| Com. Ex. 15 | — | — | — | — | — |
| Com. Ex. 16 | — | — | — | — | — |
| Com. Ex. 17 | — | — | — | — | — |
| Com. Ex. 18 | — | — | — | — | — |
| Com. Ex. 19 | — | — | — | — | — |
| Com. Ex. 20 | — | — | — | — | — |
| Com. Ex. 21 | — | — | — | — | — |
| Com. Ex. 22 | — | — | — | — | — |
| Com. Ex. 23 | — | — | — | — | — |
| Com. Ex. 24 | — | — | — | — | — |
| Com. Ex. 25 | — | — | — | — | — |
| Com. Ex. 26 | — | — | — | — | — |
| Com. Ex. 27 | — | — | — | — | — |
| Com. Ex. 28 | — | — | — | — | — |
| Com. Ex. 29 | — | — | — | — | — |
| Com. Ex. 30 | — | — | — | — | — |
| Com. Ex. 31 | — | — | — | — | — |
| Com. Ex. 32 | — | — | — | — | — |
| Com. Ex. 33 | — | — | — | — | — |

| | Volume Fraction | Saturation Magnetization Ms | | Anisotropic Magnetic Field Ha | |
|---|---|---|---|---|---|
| | of Main Phase | 453K | 300K | 453K | 300K |
| | (%) | (T) | (T) | (T) | (T) |
| Com. Ex. 15 | — | — | — | — | — |
| Com. Ex. 16 | — | — | — | — | — |
| Com. Ex. 17 | — | — | — | — | — |
| Com. Ex. 18 | — | — | — | — | — |
| Com. Ex. 19 | — | — | — | — | — |
| Com. Ex. 20 | — | — | — | — | — |
| Com. Ex. 21 | — | — | — | — | — |
| Com. Ex. 22 | — | — | — | — | — |
| Com. Ex. 23 | — | — | — | — | — |
| Com. Ex. 24 | — | — | — | — | — |
| Com. Ex. 25 | — | — | — | — | — |
| Com. Ex. 26 | — | — | — | — | — |
| Com. Ex. 27 | — | — | — | — | — |
| Com. Ex. 28 | — | — | — | — | — |
| Com. Ex. 29 | — | — | — | — | — |
| Com. Ex. 30 | — | — | — | — | — |
| Com. Ex. 31 | — | — | — | — | — |
| Com. Ex. 32 | — | — | — | — | — |
| Com. Ex. 33 | — | — | — | — | — |

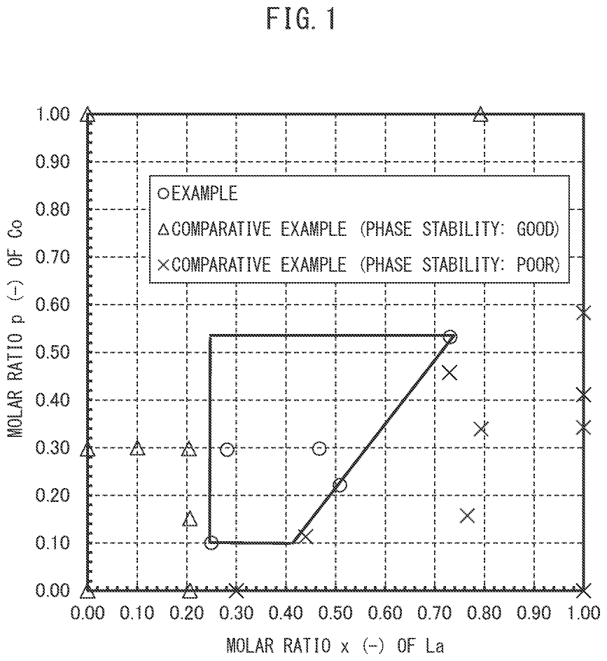

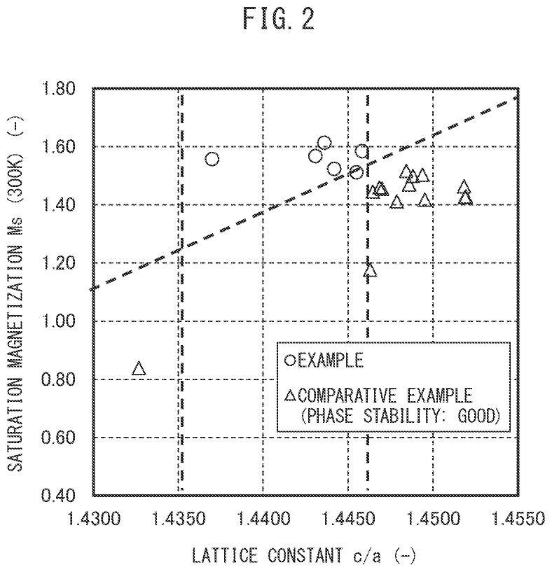

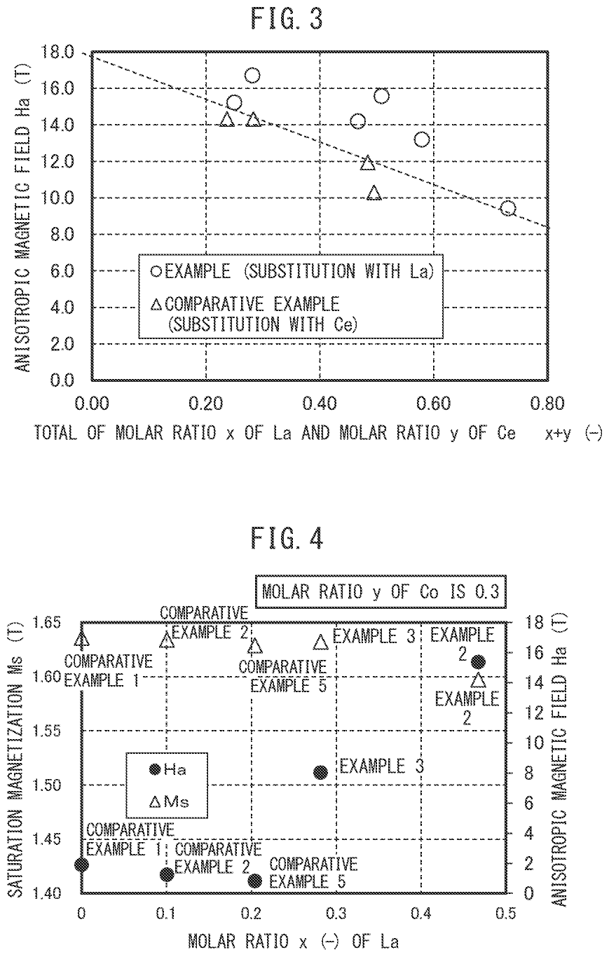

FIG. 1 is a graph illustrating the relationships of the molar ratio x of La and the molar ratio p of Co with the phase stability. In the present description, unless otherwise indicated, the phase stability means whether or not the main phase can maintain the crystal structure of at least either Th₂Zn₁₇ type or Th₂Ni₁₇ type. The phase stability being good means that the crystal structure of at least either Th₂Zn₁₇ type or Th₂Ni₁₇ type can be maintained. Also, the phase stability being poor means that it is difficult to maintain the crystal structure of at least either Th₂Zn₁₇ type or Th₂Ni₁₇ type. FIG. 2 is a graph illustrating the relationship between the lattice constant and the saturation magnetization Ms. FIG. 3 is a graph illustrating the relationship between the total of the molar ratio x of La and the molar ratio y of Ce and the anisotropic magnetic field Ha. FIG. 4 is a graph illustrating the relationship between the molar ratio x of La and the saturation magnetization Ms when the molar ratio p of Co is 0.3.

From Table 1 and FIG. 1, it can be understood that in the samples of Examples 1 to 6, the saturation magnetization was enhanced while a decrease in the anisotropic magnetic field was suppressed as much as possible. On the other hand, it can be understood that in the samples of Comparative Examples 1 to 14, although the phase stability was good, saturation magnetization enhancement was not achieved. In addition, in the samples of Comparative Examples 15 to 33, the phase stability was poor.

From Table 1 and FIG. 2, it can be understood that when the lattice constant of the main phase is from 1.4350 to 1.4460, the saturation magnetization Ms is high.

As shown by the dashed line of FIG. 3, it is expected that when part of Sm is substituted with La and Ce, the anisotropic magnetic field Ha decreases as the substitution amount with La and Ce increases. However, it can be understood from Table 1 and FIG. 3 that the samples of Examples 1 to 6 have a higher anisotropic magnetic field Ha than the anisotropic magnetic field Ha expected from the substitution ratio with La and Ce.

From Table 1 and FIG. 4, it can be understood that in the samples of Examples 2 and 3 where the molar ratio x of La is 0.25 or more, when the molar ratio of Co is 0.3, the decrease in the anisotropic magnetic field Ha poses no problem in practice.

These results can confirm the effects of the Sm—Fe—N-based magnetic material of the present disclosure and the manufacturing method thereof.

1. A Sm—Fe—N-based magnetic material comprising a main phase having a crystal structure of at least either Th₂Zn₁₇ type or Th₂Ni₁₇ type, wherein
the composition of the main phase is represented by the molar ratio formula (Sm_{(1-x-y-z)}LaₓCe_{y}R¹_{z})₂(Fe_{(1-p-q-s)}CoₚNi_{q}Mₛ)₁₇Nₕ, where
R¹ is one or more rare earth elements other than Sm, La and Ce, and Zr,
M is one or more elements other than Fe, Co, Ni and rare earth elements, and unavoidable impurity elements, and
0.25≤x+y≤0.73,
0.25≤x≤0.73,
x/(x+y)≥0.80,
0≤z≤0.10,
0.10≤p+q≤0.53,
p+q≥1.45(x+y)−0.5485,
0≤s≤0.10 and
2.9≤h≤3.3 are satisfied.

2. The Sm—Fe—N-based magnetic material according to claim 1, wherein p and q satisfy 0.22≤p+q≤0.53.

3. The Sm—Fe—N-based magnetic material according to claim 1, wherein the lattice constant of the main phase is from 1.4350 to 1.4460.

4. The Sm—Fe—N-based magnetic material according to claim 1, wherein the lattice volume of the main phase is from 0.829 to 0.838 nm.

5. The Sm—Fe—N-based magnetic material according to claim 1, wherein the volume fraction of the main phase is from 80 to 100%.

6. The Sm—Fe—N-based magnetic material according to claim 1, wherein the density of the main phase is from 7.40 to 7.76 g/cm³.

7. A production method of the Sm—Fe—N-based magnetic material according to claim 1 comprising:
preparing a magnetic material precursor having a crystal phase represented by the molar ratio formula (Sm_{(1-x-y-z)}LaₓCe_{y}R¹_{z})₂(Fe_{(1-p-q-s)}CoₚNi_{q}Mₛ)₁₇, where R¹ is one or more rare earth elements other than Sm, La and Ce, and Zr, M is one or more elements other than Fe, Co, Ni and rare earth elements, and unavoidable impurity elements, and 0.25≤x+y≤0.73, 0.25≤x≤0.73, x/(x+y)≥0.80, 0≤z≤0.10, 0.10≤p+q≤0.53, p+q≥1.45(x+y)−0.5485 and 0≤s≤0.10 are satisfied, and
nitriding the magnetic material precursor.

8. The production method of the Sm—Fe—N-based magnetic material according to claim 7, wherein p and q satisfy 0.22≤p+q≤0.53.

9. The production method of the Sm—Fe—N-based magnetic material according to claim 7, wherein the magnetic material precursor is pulverized to obtain a magnetic material precursor powder and the magnetic material precursor powder is nitrided.

10. The production method of the Sm—Fe—N-based magnetic material according to claim 7, wherein raw materials containing elements constituting the magnetic material precursor are melted and solidified to obtain the magnetic material precursor.
